(19) United States
(12) Patent Application Publication
(10) Pub. No.: US 2002/0135745 A1
(43) Pub. Date: Sep. 26, 2002

(54) Multibeam scanning device for scanning a photosensitive material with a multi-spot array, and method of correcting the position of image points of the multi-spot array

(76) Inventors: Jorg-Achim Fischer, Laboe (DE); Axel Gebhardt, Monkeberg (DE); Thomas Jacobsen, Kiel (DE); Horst Sievers, Preetz (DE); Dirk Steinke, Mielkendorf (DE)

Correspondence Address: LERNER AND GREENBERG, P.A., Post Office Box 2480, Hollywood, FL, 33022-2480, US

(21) Appl. No.: 10/073,848

(22) Filed: Feb. 11, 2002

(30) Foreign Application Priority Data
Feb. 9, 2001 (DE) 101 05 978.7

(51) Int. Cl. G03B 27/54

(52) U.S. Cl. 355/67

(57) ABSTRACT

A multibeam scanning device for scanning a photosensitive material with a multi-spot array includes a plurality of fiber exits, which are in each case detachably inserted into a holder of a mount of the multibeam scanning device. The fiber exits are aligned in order to generate a precise multi-spot array. A method for correcting the position of image points of a multi-spot array is also provided. The fiber exits are inserted into the holder such that they have a defined rotational angle in relation to their axis and such that all image points have substantially the same angular alignment in relation to their desired position. Then the distances of the individual image points from their desired positions are reduced by deflecting the laser beams and/or by delaying the time of incidence of the laser beams on the photosensitive material.

### BACKGROUND OF THE INVENTION

### FIELD OF THE INVENTION

The invention is in the field of electronic reproduction technology. More specifically, the invention relates to a process of laser engraving printing plates and to a process of exposing film with a multi-spot array by using a laser. The invention relates in particular to a multibeam scanning device for scanning a photosensitive material with a multi-spot array, including a plurality of fiber laser fiber exits, which are in each case detachably inserted into a holder in a mount of the multibeam scanning device. The invention further relates to a method of correcting the position of image points of a multi-spot array produced by imaging a plurality of fiber laser fiber exits on a photosensitive material, which is moved relative to the fiber exits, and by interrupting, deflecting and/or modulating the intensity of laser beams emerging from the fiber exits.

When laser engraving flexo printing plates in a laser exposer or laser imager, the printing plate to be processed is clamped onto a rotating drum and, in order to increase the processing speed, is scanned simultaneously with a plurality of laser beams, in order to remove the laser-sensitive layer in the subsequent printing areas of the printing plate point by point in accordance with a predefined pattern. In order to provide the power necessary for the laser engraving the multi-beam scanning devices or laser processing heads of the laser exposer used are equipped with fiber lasers, whose fiber exits are provided beside one another and are aligned with the drum or printing plate in such a way that the latter is scanned with a linear multi-spot array. The multibeam scanning devices or laser processing heads further include an optical system for imaging the fiber exits and for focussing the laser beams on the surface of the printing plate, and also devices for the selective interruption, deflection and/or intensity modulation of the individual laser beam. Such a multibeam scanning device is described in Published, Non-Prosecuted German Patent Application No. DE 100 24 456.4 corresponding to Published U.S. patent application Ser. No. U.S. 2001/0052924 A1.

In order to mount fiber exits on a laser processing head or the like, it is further known to insert the fiber exits, fitted with micro lenses or collimator lenses, into precision holes or V-shaped accommodation grooves of a mount in such a way that they have the desired alignment. Because of fabrication tolerances during the production of the fiber exits, during the fitting with the lenses and during the production of the mount or the fiber exit holders, however, in practice directional deviations of the laser beams from their intended optical axis occur, which manifest themselves in the form of position errors, that is to say deflections of individual image points of the multi-spot array in any desired direction from their desired position. Because of their repeated occurrence during the scanning, these position errors during the processing of printing plates or during the recording of an image on a film lead to disruptive patterns and therefore to an impairment of quality.

The greatest position deviations are customarily caused by so-called pointing errors of the fiber exit, that is to say the angular deviation of an emitted laser beam in relation to a cylinder axis of a capillary tube used for mounting the fiber exit and the collimator lens.

From a magazine article with the title “180-mega-pixel per second optical image recording” by Bernard M. Rosenheck, SPIE Vol. 299 Advances in Laser Scanning Technology (1981), it is already known per se to perform an electronic adjustment of image points of a two-dimensional multi-spot array by deflecting laser beams through the use of an acousto-optical modulator. In addition, electronic displacement of image points by applying voltage signals with a time delay to acousto-optical modulators is known per se in laser exposers.

### SUMMARY OF THE INVENTION

It is accordingly an object of the invention to provide a multibeam scanning device and a correction method which overcomes the above-mentioned disadvantages of the heretofore-known devices and methods of this general type and with which multi-spot arrays can be produced with high precision, so that when the photosensitive material is used as printing original, no disruptive patterns are visible on the end product.

With the foregoing and other objects in view there is provided, in accordance with the invention, a multibeam scanning device for scanning a photosensitive material with a multi-spot array, including:

a plurality of fiber exits for providing laser beams, the fiber exits having first alignment devices;

a mount having a plurality of holders for in each case a respective one of the fiber exits, the fiber exits being placed detachably into the holders, the mount having second alignment devices complementary to the first alignment devices;

a beam control device configured to perform at least one operation selected from the group consisting of interrupting the laser beams emerging from the fiber exits, deflecting the laser beams emerging from the fiber exits and modulating an intensity of the laser beams emerging from the fiber exits in order to provide a multi-spot array with image points on the photosensitive material; and

a respective one of the first alignment devices and a respective one of the second alignment devices being one of aligned and mutually engaged when a respective one of the fiber exits, which is disposed in a respective one of the holders and defines a fiber exit axis, has a previously defined rotational angle in relation to the fiber exit axis, and wherein all the image points of the multi-spot array produced on the photosensitive material by imaging the fiber exits have a respective desired position and have a substantially identical angular alignment in relation to the respective desired position when the first alignment devices of all of the fiber exits and the second alignment devices of the mount are one of aligned and mutually engaged.

The invention is based on the idea of providing, through the use of a coincident angular alignment of all the image points of the multi-spot array in relation to their respective desired position, the precondition for an electronic adjustment through the use of deflection and/or propagation-time delay of the laser beams, with which all the laser beams are shifted so far in the same direction, namely in the direction toward their desired position, until their distance from this desired position is zero or virtually zero.

The use of complementary alignment devices on the fiber exits and the mounting of the multi-beam scanning device permit rapid mounting, during the assembly of the latter and during the replacement of a defective fiber exit, in the alignment required for the electronic adjustment.

In the simplest case, the complementary alignment devices of a fiber exit and the mounting can include a color marking printed or painted onto the fiber exit, which points in a specific direction, for example vertically upward and is aligned with a corresponding marking on the mount, as soon as the fiber exit has been inserted into the holder with the previously defined rotational angle. However, the alignment device of the fiber exit preferably includes an element which projects radially beyond the fiber exit, can be brought into engagement with a form fit with a complementary element belonging to the mount when the fiber exit in the holder exhibits the previously defined rotational angle.

The more time-consuming determination of the pointing error of each fiber exit and the subsequent fixing of the alignment device in the correct rotational position on the fiber exit can be carried out at the manufacturer of the multibeam scanning device, where suitable adjustment devices are available. These preferably have a mount corresponding to the mount of the multibeam scanning device, the mount having a fiber exit holder, into which the fiber exits are inserted one after another and rotated about their axis. When the laser is switched on, an image point produced on a position detector of the adjustment device describes a circular path, whose diameter is greater the greater the pointing error of the fiber exit. As soon as the image point exhibits a predefined angular alignment in relation to a coordinate zero point of the position detector, the alignment device is fixed to the fiber exit in a fixed angular relationship, specifically in such a way that it points in the same direction in the case of all the adjusted fiber exits.

The electronic adjustment of each image point in order to reduce its distance from the respective desired position through the use of deflecting the laser beam is preferably carried out with the aid of an acousto-optical modulator which is disposed in the beam path between the fiber exit and the photosensitive material and which, in many exposers, is already present and serves there to interrupt or deflect and/or modulate the intensity of the laser beam.

In addition, the reduction in the distance of an image point from its desired position through the use of delaying the time of incidence of the laser beam can be carried out with the aid of the acousto-optical modulator, in that the voltage signals applied to the acousto-optical modulator in order to interrupt or deflect and/or modulate the intensity of the laser beams are supplied with a time delay which takes account of the distance of the respective image point from the desired position.

In order to correct pointing errors of the fiber exit, in principle one of the two aforementioned alternatives, namely deflection of the laser beams or delay of the time of incidence of the laser beams, would be sufficient if the rotational angle of the fiber exit in the mount is defined in such a way that the image points are shifted precisely in the direction of their desired position by the deflection or by the time delay.

However, since not only the fiber exits themselves but also the mount and the fiber exit holders belonging to the mount are affected by fabrication tolerances, a further preferred embodiment of the invention reduces the distances between the image points and their desired position both through the use of deflection and also through the use of a time delay of the laser beams, the two measures being carried out alternately in order to effect an iterative approach to the respective desired position. This is assisted by the fact that in the case of the drum exposers used for film exposure or laser engraving, an image point of the multi-spot array is shifted by the deflection or by the time delay of the laser beam in the acousto-optical modulator in one of two directions that are substantially perpendicular to each other, so that the approach to the desired position can be carried out in staged steps which become smaller.

According to a preferred feature of the invention, the fiber exits and the beam control device are configured to expose a film or to engrave a printing plate.

According to another feature of the invention, the beam control device includes correction devices for displacing individual ones of the image points of the multi-spot array, the correction devices deflect the laser beams electronically in a direction perpendicular to an axis extending through the desired position of given ones of the image points.

According to a further feature of the invention, the beam control device includes correction devices, the correction devices electronically delay a respective time of incidence of the laser beams on the photosensitive material for displacing individual ones of the image points of the multi-spot array on the photosensitive material in a given direction parallel to a direction of a relative movement between the fiber exits and the photosensitive material.

According to another feature of the invention, the beam control device includes a plurality of acousto-optical modulators disposed between the fiber exits and the photosensitive material.

According to another feature of the invention, the acousto-optical modulators are used as correction devices, the correction devices are configured to perform at least one operation selected from the group consisting of deflecting the laser beams and delaying a time of incidence of the laser beams for displacing individual ones of the image points.

According to a further feature of the invention, the beam control device controls the laser beams such that a converging fan of beams is formed.

According to a further feature of the invention, the beam control device includes an f-θ optical system for imaging the fiber exits telecentrically onto the photosensitive material.

According to another feature of the invention, the first alignment devices of the fiber exits each includes a radially projecting element.

According to another feature of the invention, each of the fiber exits includes a collimator lens, a fiber optic conductor, a capillary tube provided between the fiber optic conductor and the collimator lens, and a bush surrounding the capillary tube; and the radially projecting element is fixed on the bush and projects beyond the bush.

According to a further feature of the invention, the first and second alignment devices include respective markings on the fiber exits and on the mount such that the markings can be aligned in relation to one another by rotating the fiber exits in the holders.

According to a further feature of the invention a device for exposing or processing a photosensitive material with laser beams includes the multibeam scanning device according to the invention.

With the objects of the invention in view there is also provided, a method for correcting a position of image points of a multi-spot array, the method includes the steps of:

providing a multibeam scanning device configured to produce a multi-spot array by imaging a plurality of fiber exits of the multibeam scanning device on a photosensitive material that is moved relative to the multibeam scanning device and by performing at least one operation selected from the group consisting of interrupting laser beams emerging from the fiber exits, deflecting laser beams emerging from the fiber exits and modulating an intensity of laser beams emerging from the fiber exits;

inserting the fiber exits in each case into a holder of a mount of the multibeam scanning device at a previously defined rotational angle in relation to a respective longitudinal axis of the fiber exits, such that all of the image points have substantially the same angular alignment in relation to respective desired positions of the image points; and

subsequently reducing, if necessary, respective distances of the image points from the respective desired positions of the image points by performing at least one operation selected from the group consisting of deflecting the laser beams and delaying a time of incidence of the laser beams on the photosensitive material.

Another mode of the invention includes the step of reducing the respective distances of the image points from the respective desired positions of the image points until all of the image points are at the respective desired positions of the image points.

Yet another mode of the invention includes performing the steps of deflecting the laser beams and delaying a time of incidence of the laser beams on the photosensitive material in order to bring the image points step-by-step to the respective desired positions.

A further mode of the invention includes deflecting the laser beams in such a way that individual image points of the multi-spot array are shifted in a direction perpendicular to an axis extending through the desired positions of the image points in order to reduce respective distances of the image points from the desired positions of the image points.

Yet a further mode of the invention includes the step of delaying the time of incidence of the laser beams on the photosensitive material in a direction parallel to a direction of a relative movement between the multibeam scanning device and the photosensitive material.

Another mode of the invention includes interrupting laser beams emerging from the fiber exits, deflecting laser beams emerging from the fiber exits and/or modulating an intensity of laser beams emerging from the fiber exits in an acousto-optical modulator.

Yet another mode of the invention includes the step of delaying the time of incidence of the laser beams on the photosensitive material by using a time control for a supply of voltage signals to the acousto-optical modulator wherein the time control takes account of the respective distances of the image points from the desired positions of the image points.

A further mode of the invention includes deflecting the laser beams by changing a frequency of a voltage signal applied to the acousto-optical modulator for interrupting laser beams emerging from the fiber exits, deflecting laser beams emerging from the fiber exits and/or modulating an intensity of laser beams emerging from the fiber exits.

Yet a further mode of the invention includes, prior to inserting the fiber exits into the holder of the mount, rotating each of the fiber exits about the respective longitudinal axis of the fiber exits in an adjustment device until a respective image point produced by a respective one of the fiber exits has a predefined angular alignment in relation to an axis of rotation; and providing each of the fiber exits at a respective rotational position according to the predefined angular alignment with an alignment device which, when inserted into the holder of the mount, is one of aligned with and brought into engagement with a complementary alignment device of the mount.

Other features which are considered as characteristic for the invention are set forth in the appended claims.

Although the invention is illustrated and described herein as embodied in a multibeam scanning device for scanning a photosensitive material with a multi-spot array and a method of correcting the position of image points of the multi-spot array, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a perspective view of a device according to the invention for the laser engraving of flexo printing plates on a rotating drum with a linear multi-spot array;

FIG. 2 is a diagrammatic representation of the beam path in a multibeam laser processing head of the device of FIG. 1 with a row of fiber exits;

FIG. 3 is a partial sectional view of a fiber exit mount of the laser processing head, corresponding to the view of FIG. 2;

FIG. 4 is a partial sectional view of the fiber exit mount of the laser processing head, along the line IV-IV in FIG. 3;

FIG. 5 is an enlarged and simplified partial sectional view of a fiber exit and of the beam path in its vicinity;

FIG. 6 is a diagrammatic perspective view of a linear AOM array used for the modulation of the laser beams and for the electronic correction of the position of the image points of the multi-spot array;

FIG. 7 is a graph illustrating the image points of an ideal linear multi-spot array on the surface of a flexo printing plate clamped on the drum, including a light intensity distribution;

FIG. 8 is a graph corresponding to FIG. 7, however, the laser processing head and the multi-spot array have been tilted in order to achieve line connection;

FIG. 9 is a graph with a much enlarged illustration of a linear multi-spot array whose image points, as a result of pointing errors of the fiber exits, have been shifted to different extents in arbitrary directions from their desired positions;

FIG. 10A is a graph with an illustration of the multi-spot array from FIG. 9 after a rotation of the fiber exits into an angular position in which all the image points have the same angular alignment in relation to their desired positions;

FIG. 10B is a diagrammatic view of an enlarged detail of FIG. 10A;

FIG. 11 is a graph corresponding to FIG. 10A, however, the laser processing head and the multi-spot array have been tilted in order to achieve line connection;

FIG. 12A is a graph illustrating the multi-spot array of FIG. 9 after a rotation of the fiber exits into another angular position, in which all the image points likewise have the same angular alignment in relation to their desired positions;

FIG. 12B is a diagrammatic view of an enlarged detail of FIG. 12A;

FIG. 13A is a graph corresponding to FIG. 12A, however, the laser processing head and the multi-spot array have been tilted in order to achieve line connection;

FIG. 13B is a diagrammatic view of an enlarged detail of FIG. 13A; and

FIG. 14 is a graph illustrating the multi-spot array corresponding to FIG. 9 after a rotation of the fiber exits corresponding to FIG. 10A, but as a result of fabrication tolerances of the mount, not all the image points have the same angular alignment in relation to their desired positions.

### DESCRIPTION OF THE PREFERRED EMBODIMENTS

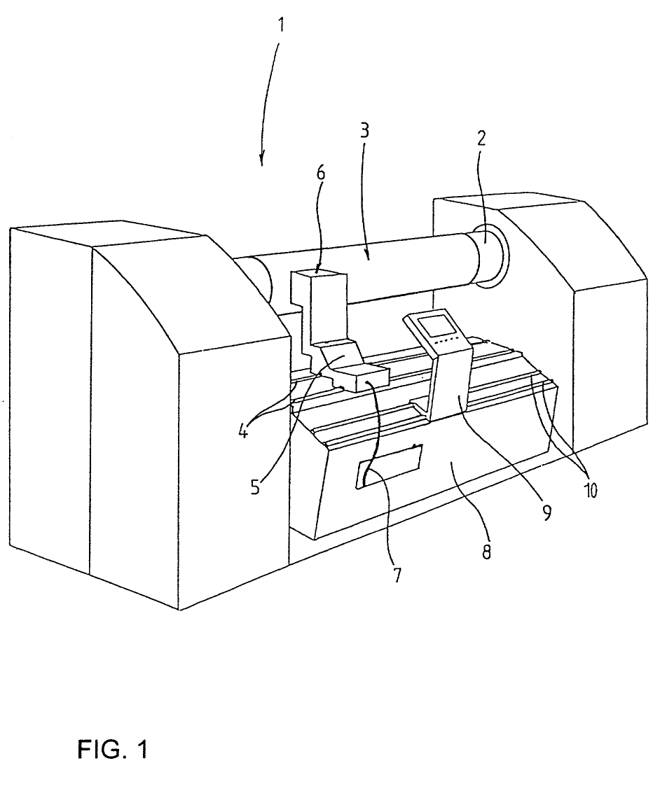

Referring now to the figures of the drawings in detail and first, particularly, to FIG. 1 thereof, there is shown a device 1 for laser engraving flexo printing plates which essentially includes a drum 2 which is rotatably clamped between two lateral mounts and on whose circumferential surface the flexo printing plates 3 to be processed are clamped, a rotary drive (not illustrated) for rotating the drum 2 and a printing plate 3 clamped thereon, a carriage 5 which can be moved on guides 4 in the axial direction of the drum 2 and of the printing plate 3, a laser processing head 6 which is mounted on the carriage 5 and which is connected by a bundle of eight fiber optic conductors 7 to a multibeam YAG (Yttrium Aluminum Garnet) laser in a stationary underpart 8 of the device 1, and also a control desk 9 which can likewise be moved on guides 10 in the axial direction along the drum 2.

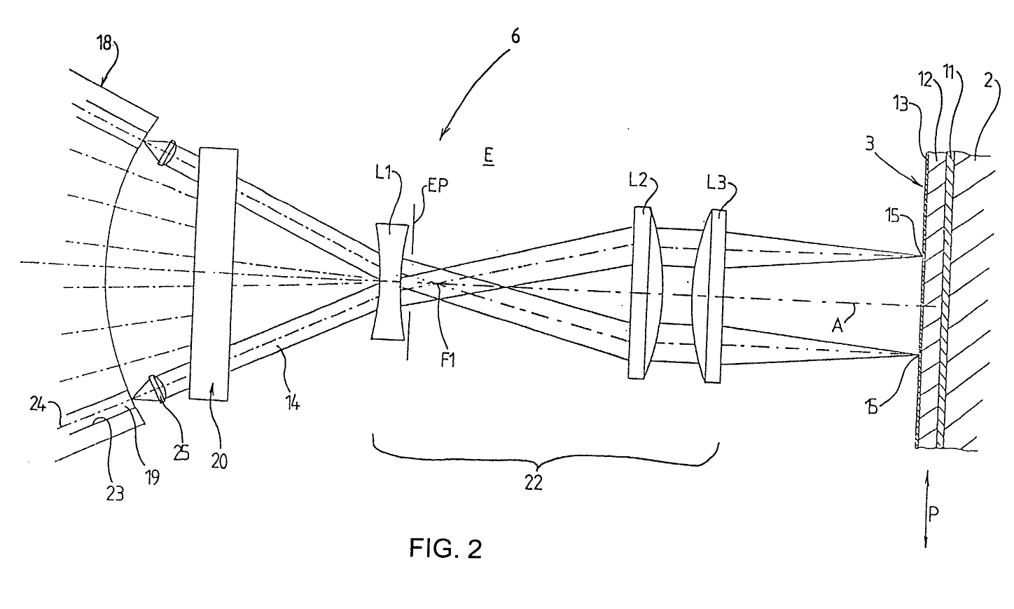

As best illustrated in FIG. 2, the commercially available flexo printing plate 3 clamped onto the drum 2 for laser engraving substantially includes, in a known way, a lower carrier layer 11 made of metal or polymer, preferably a polyester film, a photopolymer layer 12 applied to the top of the carrier layer 11 and containing unsaturated monomers and elastomeric binders which are crosslinked to form long-chain polymers when exposed to UVA light, and also a laser-sensitive layer 13 opaque to UV radiation which is applied to the top of the photopolymer layer 12.

During the laser engraving, the flexo printing plate 3 is scanned in accordance with a predefined dot pattern simultaneously by eight laser beams 14 which are focussed onto the laser-sensitive layer 13, as illustrated schematically in FIG. 2 by two of the laser beams 14. In the process, the laser-sensitive layer 13 is removed by ablation at the points of incidence 15 of the laser beams 14 which are intended to transfer printing ink during the subsequent printing operation, while the laser-sensitive layer is maintained in the remaining areas. The ablation is a thermal process, in which the laser-sensitive layer 13 evaporates down as far as the photopolymer layer 12, forming dot-like openings, and is removed as a result. During subsequent irradiation with UV light, the photopolymer layer 12 cures under the openings and, as opposed to the remaining areas, is not washed out during the subsequent development. The wavelength of the laser radiation emitted by the YAG lasers lies in the infrared range, while the photopolymer is sensitive in the UV range, so that it is not influenced by the laser light during the scanning with the laser beams 14. The scanning of the flexo printing plate 3 is carried out in a predefined dot pattern, which is produced in the form of digital pixel data by a raster image processor (not illustrated) from the text or image information to be transferred to the printing plate 3.

The 8-channel laser processing head 6 moved in the axial direction P of the drum 2 along the printing plate 3 substantially includes a mount 18 for the fiber exits 19 of the eight fiber optic conductors 7, a linear AOM (Acousto-Optical Modulator) array 20 for modulating the intensity of the individual laser beams 14, and also of an f-θ optical system 22 which has a focal point F1 and which includes three lenses L1, L2 and L3 with which the fiber exits 19 are imaged telecentrically as a linear multi-spot array on the surface of the printing plate 3.

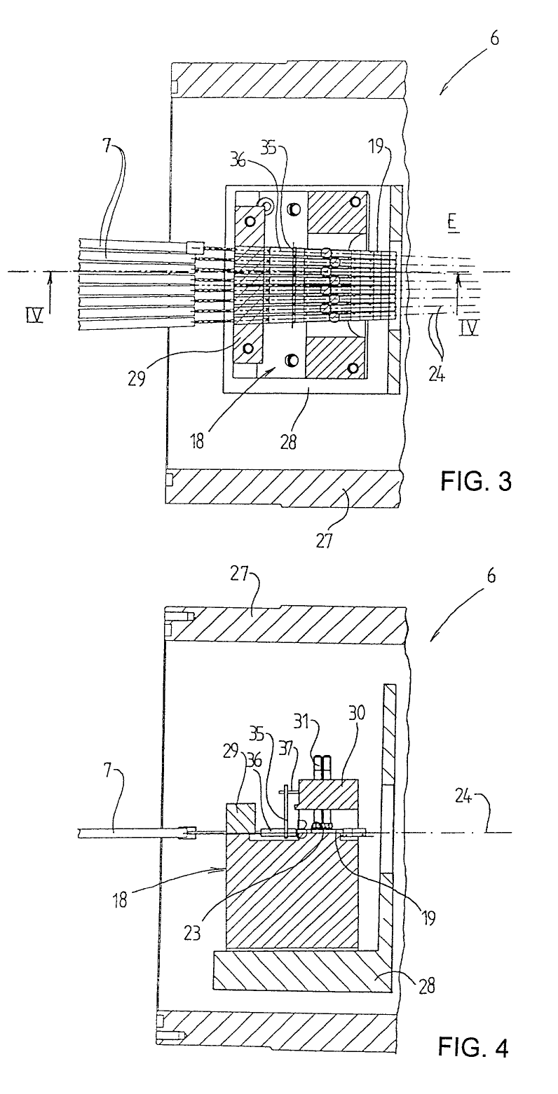

As best illustrated in FIGS. 3 and 4, the fiber exits 19 are inserted with an angular spacing of about 10 mrad beside one another in a fan shape into V-shaped holding grooves 23 in the mount 18, so that the optical axes 24, lying in one plane E, of the laser beams 14 emerging from the fiber exits 19, after passing through the AOM array 20, intersect at an entry pupil or aperture EP of the optical system 22, as illustrated schematically in FIG. 2 with larger angular spacings, when they have been deflected into the 1st order in the AOMs 21 of the AOM array 20 in order to image the fiber exits 19 on the printing plate 3.

The mount 18, mounted in a cylindrical mounting tube 27 of the laser processing head 6 on a carrier 28 has a rear fixing part 29, facing away from the drum 2, for the fiber exits 19, in which part the latter are clamped for strain relief and also a front holding part 30, facing the drum 2, in which each of the fiber exits 19 is pressed downward into the associated holding groove 23 by a spring-loaded plunger 31.

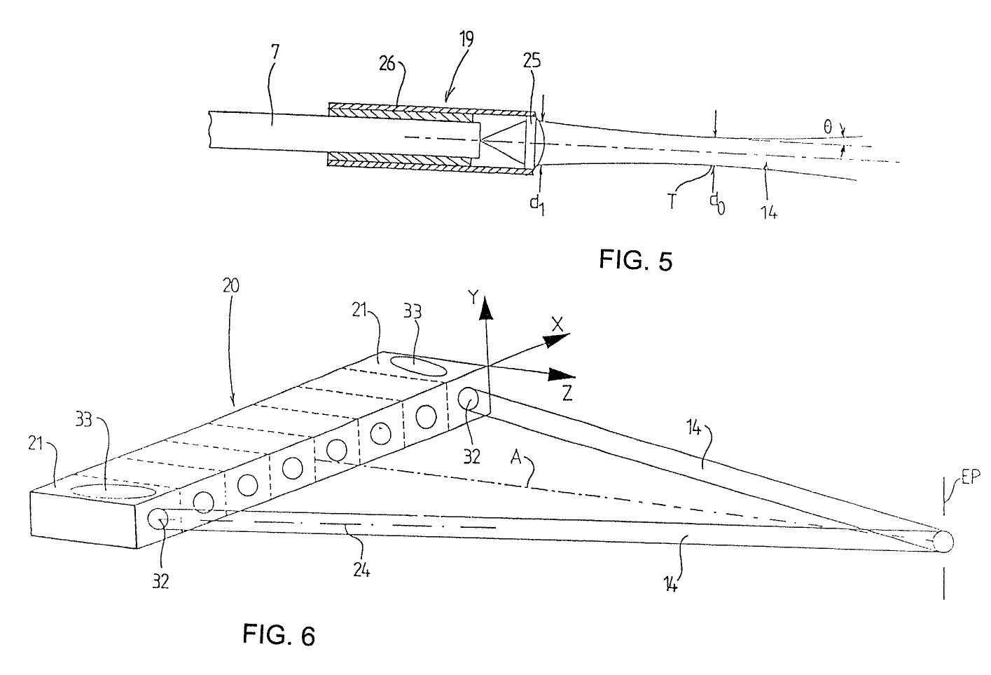

As best illustrated in FIG. 5, the fiber exits 19 substantially include a cylindrical capillary tube 26, into whose one end the end of one of the fiber optic conductors 7 is inserted and its other end serves as a mount for a collimator lens or micro lens 25, which focuses the laser beams emerging from the fiber exit 19. The focal length f of the micro lens 25 is between f=3 mm and f=7 mm, depending on the numerical aperture of the fiber optic conductor. The beam diameter d of the laser beam 14 emerging from the micro lens 25 changes from a diameter d₁ of about 850 μm directly behind the micro lens 25 to a waist diameter d₀ of about 700 μm at 1/e² and, after that, increases again, with a divergence angle θ=2λ/π d₀, from about 1 mrad at a beam diameter of d₀=700 μm, as illustrated by the curved marginal beams.

As best illustrated in FIG. 6, the AOM array 20 provided in the region of the laser beam fan is suitably positioned with respect to axes X, Y, Z and has in each case one AOM 21 for each laser beam 14. In terms of their construction, the AOMs 21 correspond to known acousto-optical modulators and include a crystal 32 that is transparent to the laser beam 14 and a piezoelectric converter 33 (only partly shown), which emits ultrasonic waves into the crystal 32 when a voltage signal is applied to the converter 33. As it passes through the crystal 32, the laser beam 14 is diffracted at the ultrasonic waves produced by the converter 33, either, depending on the respective amplitude of the voltage signal, being deflected as a light beam of first order toward the entry pupil EP of the optical system 22 and from there to the flexo printing plate 3 or being masked out as a light beam of the 0th order, depending on whether the laser-sensitive layer 13 of the printing plate 3 is to be removed at the appropriate point or not. The amplitude of the voltage signal is controlled on the basis of the pixel data.

The AOM array 20 is provided at a point in the beam path of the laser beams 14 at which the intervals between the individual AOMs 21 correspond to the intervals between the associated laser beams 41, and is aligned in such a way that the laser beams 14 in each case enter an optical entry surface of the AOMs approximately at the Bragg angle. In order to improve the diffraction efficiency of the AOMs 21 and to lead the laser beams 14 through the AOMs 21 as far as possible without vignetting, the converters 33 on the individual AOMs 21 are in each case aligned in parallel with the optical axis 24 of the laser beam 14 passing through.

The AOM array 20 and the entry pupil EP of the optical system 22 are each at such a distance from the waist T of the laser beams 14 (FIG. 5) that both the AOMs 21 and the entry pupil EP lie within the Rayleigh distance, within which the diameter of the laser beam 14 increases to d₀×\sqrt{2}.

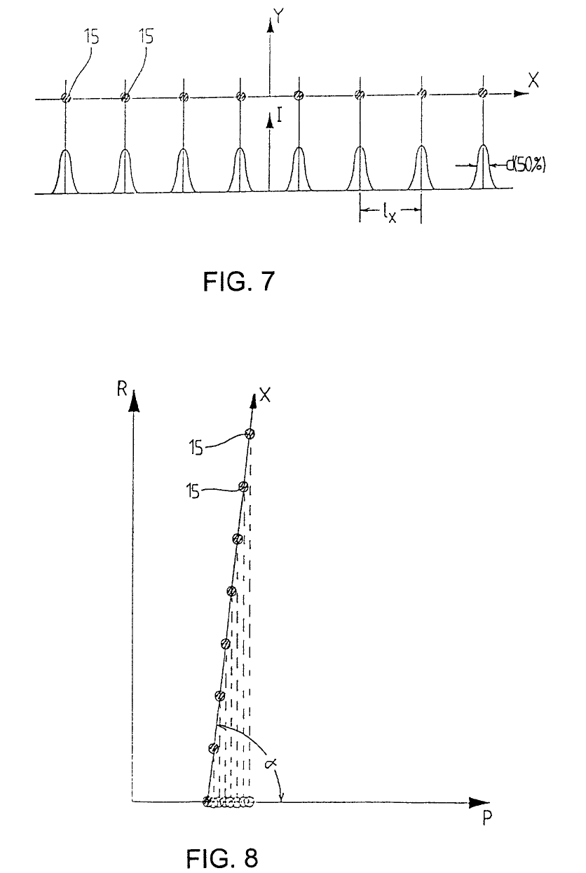

Ideally, the laser beams 14 emerging from the micro lenses 25 of the fiber exits 19 are parallel to the respective cylinder axes of the capillary tubes 26, and the holding grooves 23 have the same angular spacings and heights, as a result of which the fiber exits 19 are theoretically imaged on the printing plate 3 as an ideal multi-spot array, whose image points all lie on one axis X and are at the same intervals, as illustrated in FIG. 7. Given an angular spacing of the fiber exits 19 of 10 mrad and a spacing/diameter ratio of 8 to 1 in the mount 18, the result for the points of incidence 15 of the eight laser beams 14 on the laser-sensitive layer 13 and therefore for adjacent image points of the linear multi-spot array is center spacings 1× of about 160 μm and spot diameters d(50%) of about 20 μm for their respective intensity I.

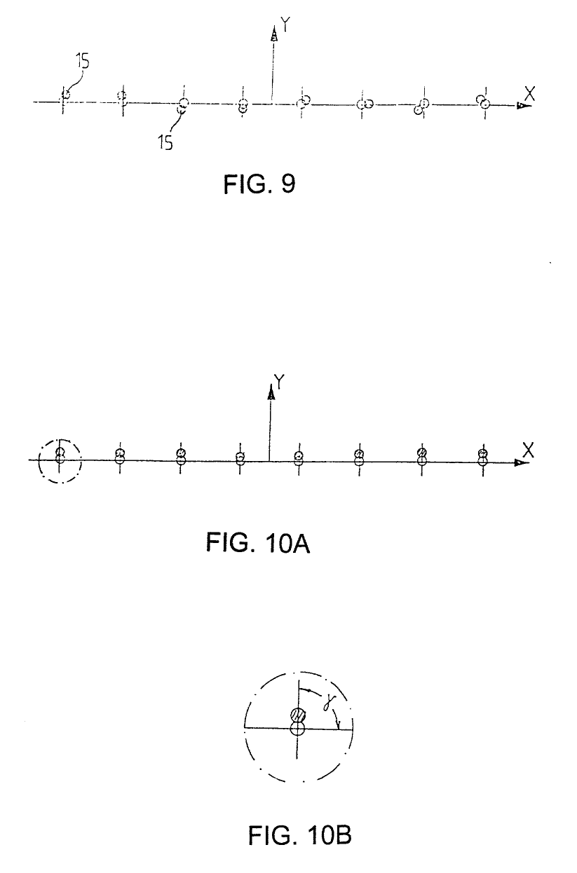

In practice, however, the multi-spot array is only seldom ideal, firstly, because the laser beams 14 emerging from the micro lenses 25, because of so-called pointing errors of the fiber exits 19, exhibit more or less large angular deviations from the cylinder axis of the capillary tube 26, and secondly because the holding grooves 23 belonging to the mount 18, on account of fabrication tolerances, are not always provided equidistantly and at the same height. As a result of the pointing errors, at least some of the image points of the multi-spot array exhibit deviations from the desired position on the printing plate, as illustrated somewhat exaggeratedly in FIG. 9, commonly both the distances between the image points and their desired positions (illustrated as white circles) and the directions or angular directions of the image points in relation to their desired positions being different.

In order to correct these deviations from the respective desired position, according to the invention, firstly all the fiber exits 19 are inserted mechanically into the holding grooves 23 in such a way that all the image points of the multi-spot arrays have substantially the same angular alignment in relation to their desired position, as illustrated in FIGS. 10A and 12A by using two examples, before the distances of the individual image points from their desired position, if necessary, is then reduced electronically through the use of appropriate deflection of the laser beams 14 in the AOMs 21 and/or through the use of appropriate delay of the times of incidence of the laser beams 14 on the printing plate 3. The two electronic correction steps can in each case be carried out individually or alternately one after the other, until the distances are reduced to zero or virtually zero.

Here, the same angular alignment means that the direction vectors from the respective desired position to the respective image point exhibit the same angle γ with the axis X running through all the desired positions and, preferably, the same sign. If the angular errors of the laser beams 14 are relatively small and the bandwidth of the AOMs 21 is sufficient in order to correct the errors substantially through the use of deflecting the laser beams 14 in the AOM 21, the angles γ are preferably selected such that, as in the multi-spot array illustrated in FIG. 10A, they are all 90°. If the angular errors are greater, so that the bandwidth of the AOMs 21 available for the correction is inadequate, the angles γ are preferably selected such that, as in the multi-spot array illustrated in FIG. 12A, they are in each case 7.13° (corresponding to 90°—arctan 1×/d(50%)), so that the deviations from the desired position can substantially be corrected through the use of an appropriately adapted time delay of the voltage signals.

A substantially coincident angular alignment of all the image points is achieved if the fiber exits 19 in each case are inserted into the holding grooves 23 in the mount 18 with such a rotational position in relation to the cylinder axis of their capillary tubes 26 that the pointing errors of all the fiber exits 19 point in the same direction. The rotational position of each fiber exit 19 required for this purpose is determined, before the latter is mounted in the mount 18 of the laser processing head 6, in an adjusting device in which each fiber exit 19 is inserted into a holding groove corresponding to the holding grooves 23 and, with the laser light switched on, is rotated about its axis, while the position of an image point produced on a position detector by the emerging laser beam 14 is recorded. During the rotation of the fiber exit, this image point describes a circular path, whose diameter is greater the greater the pointing error of the fiber exit 19. Every time the image points exhibit a desired angular alignment in relation to the axis or in relation to a corresponding coordinate system belonging to the adjusting device, for example lie vertically above the axis, a marking is applied to the fiber exit 19, which corresponds to this angular alignment and, for example, likewise points upward. Following the determination of the pointing errors of all the fiber exits 19, the latter are inserted into the holding grooves 23 in the mount 18 in such a way that all the markings point in the same direction, for example upward again.

Instead of being provided with markings, the fiber exits 19 illustrated in FIG. 4 are in each case provided with a flag 35 which projects radially beyond the capillary tube 26 and which indicates the direction of the pointing error of the fiber exit 19 or a defined angular distance from the error. The flag 35 is part of a rotatable cylindrical bush 36 which is pushed onto the capillary tube 26 and which, in the adjusting device, is firmly adhesively bonded on the capillary tube 26 in accordance with the direction of the pointing error. At its upper end, the flag 35 has an alignment notch (not visible), in which an alignment pin 37 which is inserted into the mount 18 in a fixed position, above the fiber exit 19, and is parallel to the respective holding groove 23, engages. This measure not only ensures that the fiber exits 19 are inserted into the holding grooves 23 in the previously defined rotational position, but also prevents subsequent rotation of the fiber exits 19 about their axis.

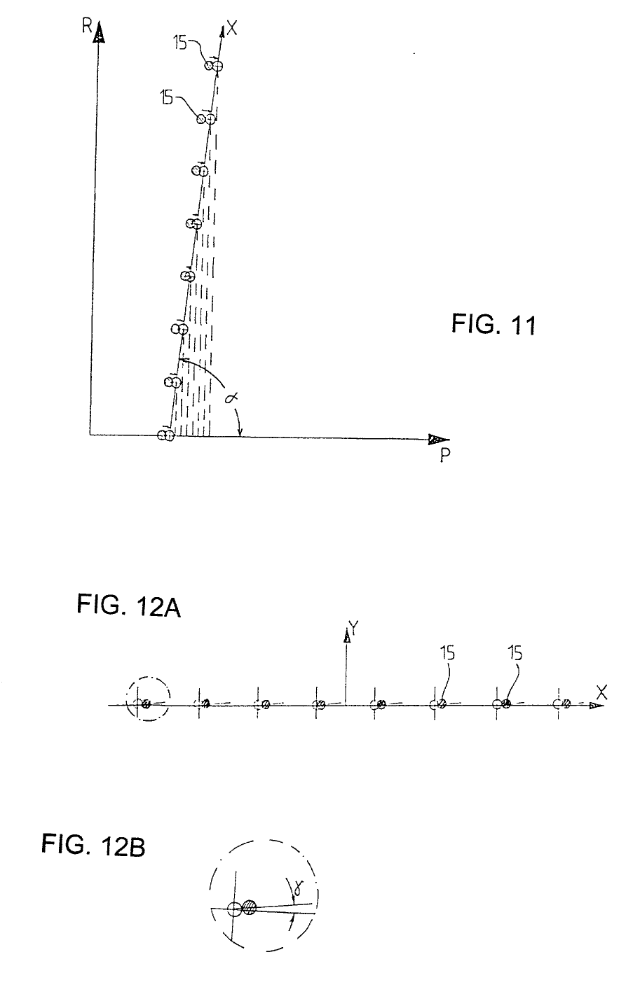

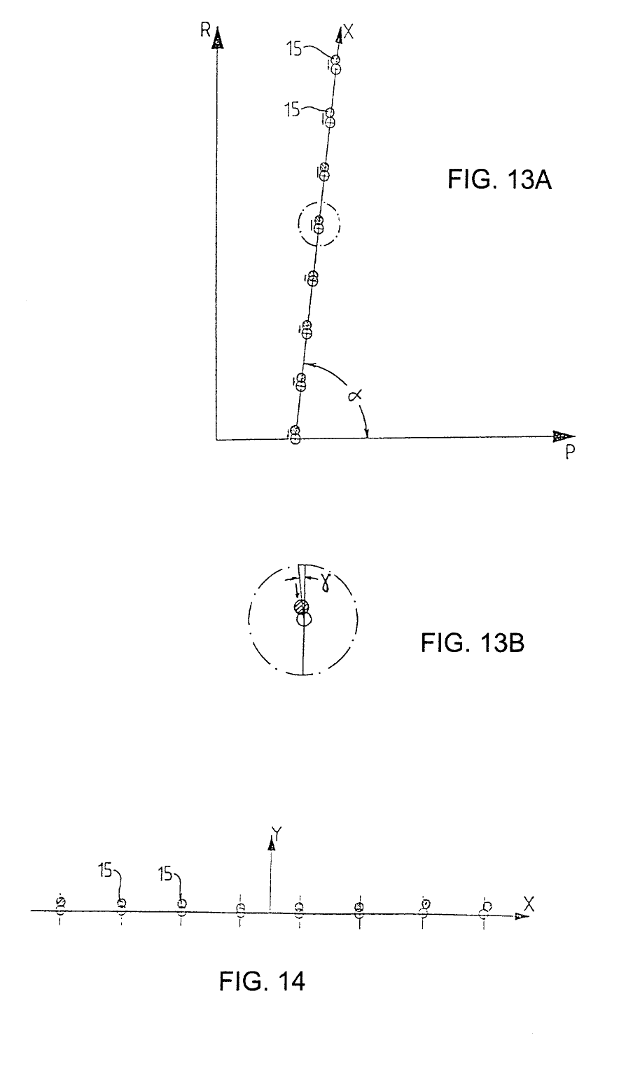

In order to achieve line connection, that is to say to reduce the center spacings 1× between two adjacent image points in the axial direction P of the drum 2 to such an extent that the two points 15 overlap at 50% of the maximum intensity, that is to say at d(50%), the plane E covered by the converging laser beams 14 after the fiber exits 19 have been inserted into the holding grooves 23 are tilted about the axis A, by rotating the entire laser processing head 6, out of the position in relation to the axis P illustrated in FIG. 2, so that the multi-spot array is aligned at an angle α=arctan 1×/d(50%)=arctan 8/1=82.87° with respect to the drum feed direction P or at an angle 90°-α with respect to the drum circumferential direction R, as illustrated in FIGS. 11 and 13A. In addition, the individual AOMs 21 of the AOM array 20 have the voltage signals applied to them with an appropriate time delay, depending on the rotational speed of the drum 2, so that the eight laser beams 14 strike the laser-sensitive layer 13 on the printing plate 3 simultaneously beside one another in the drum feed direction P.

In order to correct the deviations of the image points from their desired positions, in the multi-spot array illustrated in FIG. 11, the laser beams 14 are additionally deflected, by changing the frequency of the voltage signals supplied to the AOMs 21 in a direction perpendicular to the axis X (indicated by small arrows) to such an extent that the image points previously rotated in this direction (cf. FIG. 11) come to lie on the axis X.

By contrast, in the multi-spot array illustrated in FIG. 13A, the correction of the deviations of the image points from their desired positions is carried out through the use of a different time delay in the drum circumferential direction R (indicated by small arrows), this time delay being set for each laser beam 14 in such a way that the associated image point comes to lie on the axis X.

If the angular alignment of one or more image points changes following the insertion of the fiber exits 19 into the holding grooves 23, because of fabrication tolerances during the production of the mount 18, as illustrated in FIG. 14 using the example of the two image points on the furthest right, the aforementioned correction steps (deflection or propagation-time delay) are carried out iteratively until the image points assume their desired positions.

The electronic correction is carried out with the aid of test images which, in each case after a correction step has been carried out, are created with the aid of a test printing plate that is clamped onto the drum, the correction being carried out step by step until no disruptive patterns are visible on the test images. Alternatively, before the exposure of the first test printing plate, a correction can be made in which the pointing errors measured in the adjusting device are compensated for, in terms of their respective magnitude i.e. their respective absolute value, through the use of an appropriate deflection and/or time delay of the respective laser beam.

We claim:

1. A multibeam scanning device for scanning a photosensitive material with a multi-spot array, comprising:
a plurality of fiber exits for providing laser beams, said fiber exits having first alignment devices;
a mount having a plurality of holders for in each case a respective one of said fiber exits, said fiber exits being placed detachably into said holders, said mount having second alignment devices complementary to said first alignment devices;
a beam control device configured to perform at least one operation selected from the group consisting of interrupting the laser beams emerging from said fiber exits, deflecting the laser beams emerging from said fiber exits and modulating an intensity of the laser beams emerging from said fiber exits in order to provide a multi-spot array with image points on the photosensitive material; and
a respective one of said first alignment devices and a respective one of said second alignment devices being one of aligned and mutually engaged when a respective one of said fiber exits, which is disposed in a respective one of said holders and defines a fiber exit axis, has a previously defined rotational angle in relation to the fiber exit axis, and wherein all the image points of the multi-spot array produced on the photosensitive material by imaging the fiber exits have a respective desired position and have a substantially identical angular alignment in relation to the respective desired position when said first alignment devices of all of said fiber exits and said second alignment devices of said mount are one of aligned and mutually engaged.

2. The multibeam scanning device according to claim 1, wherein said fiber exits and said beam control device are configured to expose a film as the photosensitive material.

3. The multibeam scanning device according to claim 1, wherein said fiber exits and said beam control device are configured to engrave a printing plate as the photosensitive material.

4. The multibeam scanning device according to claim 1, wherein said beam control device includes correction devices for displacing individual ones of the image points of the multi-spot array, said correction devices deflect the laser beams electronically in a direction perpendicular to an axis extending through the desired position of given ones of the image points.

5. The multibeam scanning device according to claim 1, wherein said beam control device includes correction devices, said correction devices electronically delay a respective time of incidence of the laser beams on the photosensitive material for displacing individual ones of the image points of the multi-spot array on the photosensitive material in a given direction parallel to a direction of a relative movement between said fiber exits and the photosensitive material.

6. The multibeam scanning device according to claim 1, wherein said beam control device includes a plurality of acousto-optical modulators disposed between said fiber exits and the photosensitive material.

7. The multibeam scanning device according to claim 6, wherein said acousto-optical modulators are used as correction devices, said correction devices are configured to perform at least one operation selected from the group consisting of deflecting the laser beams and delaying a time of incidence of the laser beams for displacing individual ones of the image points.

8. The multibeam scanning device according to claim 1, wherein said beam control device controls the laser beams such that a converging fan of beams is formed.

9. The multibeam scanning device according to claim 1, wherein said beam control device includes an f-θ optical system for imaging said fiber exits telecentrically onto the photosensitive material.

10. The multibeam scanning device according to claim 1, wherein said first alignment devices of said fiber exits each includes a radially projecting element.

11. The multibeam scanning device according to claim 10, wherein:
each of said fiber exits includes a collimator lens, a fiber optic conductor, a capillary tube provided between said fiber optic conductor and said collimator lens, and a bush surrounding said capillary tube; and
said radially projecting element is fixed on said bush and projects beyond said bush.

12. The multibeam scanning device according to claim 1, wherein said first and second alignment devices include respective markings on said fiber exits and on said mount such that said markings can be aligned in relation to one another by rotating said fiber exits in said holders.

13. A device for one of exposing and processing a photosensitive material with laser beams including the multibeam scanning device according to claim 1.

14. A method for correcting a position of image points of a multi-spot array, the method which comprises:
providing a multibeam scanning device configured to produce a multi-spot array by imaging a plurality of fiber exits of the multibeam scanning device on a photosensitive material that is moved in relation to the multibeam scanning device and by performing at least one operation selected from the group consisting of interrupting laser beams emerging from the fiber exits, deflecting laser beams emerging from the fiber exits and modulating an intensity of laser beams emerging from the fiber exits;
inserting the fiber exits in each case into a holder of a mount of the multibeam scanning device at a previously defined rotational angle in relation to a respective longitudinal axis of the fiber exits, such that all of the image points have substantially the same angular alignment in relation to respective desired positions of the image points; and
subsequently reducing, if necessary, respective distances of the image points from the respective desired positions of the image points by performing at least one operation selected from the group consisting of deflecting the laser beams and delaying a time of incidence of the laser beams on the photosensitive material.

15. The method according to claim 14, which comprises reducing the respective distances of the image points from the respective desired positions of the image points until all of the image points are at the respective desired positions of the image points.

16. The method according to claim 14, which comprises alternately performing the steps of deflecting the laser beams and delaying a time of incidence of the laser beams on the photosensitive material in order to bring the image points step-by-step to the respective desired positions.

17. The method according to claim 14, which comprises deflecting the laser beams in such a way that individual image points of the multi-spot array are shifted in a direction perpendicular to an axis extending through the desired positions of the image points in order to reduce respective distances of the image points from the desired positions of the image points.

18. The method according to claim 14, which comprises delaying the time of incidence of the laser beams on the photosensitive material in a direction parallel to a direction of a relative movement between the multibeam scanning device and the photosensitive material.

19. The method according to claim 14, which comprises performing the at least one operation selected from the group consisting of interrupting laser beams emerging from the fiber exits, deflecting laser beams emerging from the fiber exits and modulating an intensity of laser beams emerging from the fiber exits in an acousto-optical modulator.

20. The method according to claim 19, which comprises delaying the time of incidence of the laser beams on the photosensitive material by using a time control for a supply of voltage signals to the acousto-optical modulator wherein the time control takes account of the respective distances of the image points from the desired positions of the image points.

21. The method according to claim 19, which comprises deflecting the laser beams by changing a frequency of a voltage signal applied to the acousto-optical modulator for performing the at least one operation selected from the group consisting of interrupting laser beams emerging from the fiber exits, deflecting laser beams emerging from the fiber exits and modulating an intensity of laser beams emerging from the fiber exits.

22. The method according to claim 14, which comprises:
prior to inserting the fiber exits into the holder of the mount, rotating each of the fiber exits about the respective longitudinal axis of the fiber exits in an adjustment device until a respective image point produced by a respective one of the fiber exits has a predefined angular alignment in relation to an axis of rotation; and
providing each of the fiber exits at a respective rotational position according to the predefined angular alignment with an alignment device which, when inserted into the holder of the mount, is one of aligned with and brought into engagement with a complementary alignment device of the mount.
